(19) United States
(12) Patent Application Publication
(10) Pub. No.: US 2011/0302748 A1
(43) Pub. Date: Dec. 15, 2011

(54) SKATEBOARDER'S SHOELACE CLAMP AND METHODS OF USE

(76) Inventor: Raymond Michael Avelar, Parker, CO (US)

(21) Appl. No.: 12/814,092

(22) Filed: Jun. 11, 2010

(51) Int. Cl. A43C 7/00; A44B 17/00; A44B 99/00; A44B 18/00; B23P 17/04; A43B 23/00

(52) U.S. Cl. 24/306; 29/428; 36/136; 24/713.6; 24/304

(57) ABSTRACT

A device for securing shoelaces without needing to tie the shoelaces is disclosed. One embodiment of the device comprises a pair of small, planar fastener disks with an aperture cutout in each disk. Aglets at each end of a shoelace are inserted through fastener-disk apertures and the fasteners are slid down to a desired point or tension on the shoelace, next to one of the article of footwear's eyelets. Because the fastener disks develop a frictional grip on the shoelace, tension in the shoelace is substantially maintained. Importantly, the device can be used to simultaneously secure and article of footwear on a wearer's foot while providing a false impression that the article of footwear is untied and unsecured, a feature desired by the skateboarding community. Additionally, one or more such devices can be used to ornament an article of footwear on the exterior sides of footwear eyelets.

### BACKGROUND OF THE INVENTION

Traditionally, shoelaces are used to secure an article of footwear to a wearer's foot, and traditionally, such laces are tied in a specialized knot that allows for later release. However, the time it takes to ties shoes is burdensome for some people, and the releasable knots can inadvertently turn into tangled, unreleasable knots. For example, a tri-athlete needs to be able to quickly don and remove athletic shoes as he or she switches between the legs of triathlon events.

In addition, an unusual fashion/cultural phenomenon has emerged within the skateboarding community such that it is “uncool” for a “Boarder” to have tied shoelaces when plying their craft. Of course, having untied shoelaces presents the very real practical problem of having shoes that will not easily stay on the Boarder's feet as the Boarder leaps, twists, and/or pushes off.

Many have devised various solutions to the shoelace-securing problem, many which are overly complicated and most which are unsightly from a fashion standpoint. For example:
U.S. Pat. No. 5,119,539 to Curry: This reference discloses a lace fastener that uses a single, large disk with holes and slots cut into it, wherein the single large disk is used to engage both ends of the shoelace simultaneously to secure the shoelaces. Further, this device does not hide the fact that the shoelaces are in fact secured by the large disk, which is disposed in the middle of and on top of the shoe. This solution would fail the need to provide an easy, non-tying securing means for the shoelaces, while hiding the fact that the shoelaces are in fact secured.
U.S. Pat. No. 5,613,283 to Yusfan: This reference discloses a lace-closure system where in each lace has its own securing disk, with the securing disk having a single slot cut from the center to the perimeter of the disk, which forms a slot for a lace to be slid in from the perimeter of the disk. Each end of the shoe lace must also have a series of “closure members”, and each lace section between two closure members can be slid into the disk slot by a user to secure the shoelace at the desired tension. Again, this solution makes no attempt to hide the securing means, and frankly is likely not of much aesthetic appeal to consumers.
U.S. Pat. No. 4,290,173 to Herláu: This reference discloses a means to releasably secure strings. More specifically, it requires the use of two parallel disks, one having a frustoconical shape on the side that mates with the other disk. The mating of the disks forms a wedge, which is used to secure a string that is fed through a hole in one of the disks. Once again, this solution does not facilitate the hiding of the securing of the shoelaces, and is also unnecessarily complex.

What is needed is a device that is economical to manufacture that can be easily used to discretely and effectively secure a laced article of footwear to a wearer's foot.

### BRIEF DESCRIPTION OF THE DRAWINGS

FIG. 1 depicts one embodiment of a fastener disk used to frictionally engage and secure a footwear lace.

FIG. 2 depicts one embodiment of a fastener disk used to frictionally engage and secure a footwear lace.

FIG. 3 depicts one embodiment of a fastener disk used to frictionally engage and secure a footwear lace.

FIG. 4 depicts one embodiment of a fastener disk used to frictionally engage and secure a footwear lace.

FIG. 5 depicts one embodiment of a fastener disk actually engaging an elasticized footwear lace just above the eyelet of an article of footwear.

FIG. 6 depicts one embodiment of a fastener disk that has been adapted to be fixed to the interior-side of an eyelet of a target article of footwear. In this particular exemplary case, the fastener disk mechanically snaps onto the interior side of a target eyelet on an article of footwear, where the eyelet has the male part of the snap coupling, but still has an opening in the middle to receive a footwear lace, and the fastener disk has the female part of the snap coupling.

FIG. 7 depicts one embodiment of a fastener disk being slid down a footwear lace on an article of footwear, with the goal being to seat the fastener disk on or near the interior side of a target eyelet.

FIG. 8 depicts one embodiment of a fastener disk engaged with a footwear lace and that has just been seated on the interior side of a target eyelet.

FIG. 9 depicts one embodiment of a pair of fastener disks seated on the interior side of respective second-tier eyelets of a shoe, such that the footwear laces passing through the top-most pair of eyelets can maintain an appearance of being unsecured. It should be noted that the fastener disks in this figure have intentionally been oversized to facilitate the reader's understanding as to their position. It should be appreciated by one ordinarily skilled in the art that much smaller, and therefore discrete, fastener disks can be used.

FIG. 10 depicts one embodiment of a fastener disk engaged with a footwear lace and being applied to the exterior side of one of the top-most eyelets on a shoe.

FIG. 10 depicts one embodiment of a fastener disk engaged with a footwear lace and being applied to the exterior side of one of the top-most eyelets on a shoe.

FIG. 11 depicts one embodiment of a pair of fastener disks engaged with a footwear lace on each end, each fastener disk which has been seated on the exterior side of its associated top-most eyelet on a shoe. In addition to providing security of fit of the article of footwear on a wearer's foot, this configuration can be used to ornament the article of footwear, and a plurality of fastener disks can be applied to any number of the shoe's eyelets on the exterior side.

### DETAILED DESCRIPTION

### Overview

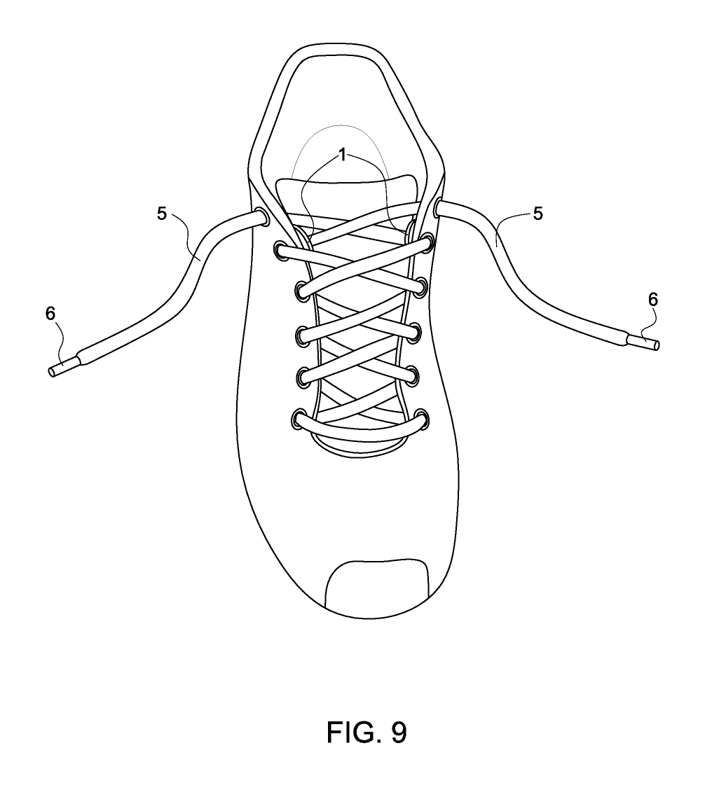

The various embodiments of the invention encompass a small, easily manufactured, device for discretely securing the laces of an article of footwear, in particular, shoes worn by skateboarders, who have a fashion/cultural need within the sport to appear to have untied shoes while still being able to secure such shoes on a skateboarder's foot (see, e.g., FIG. 9).

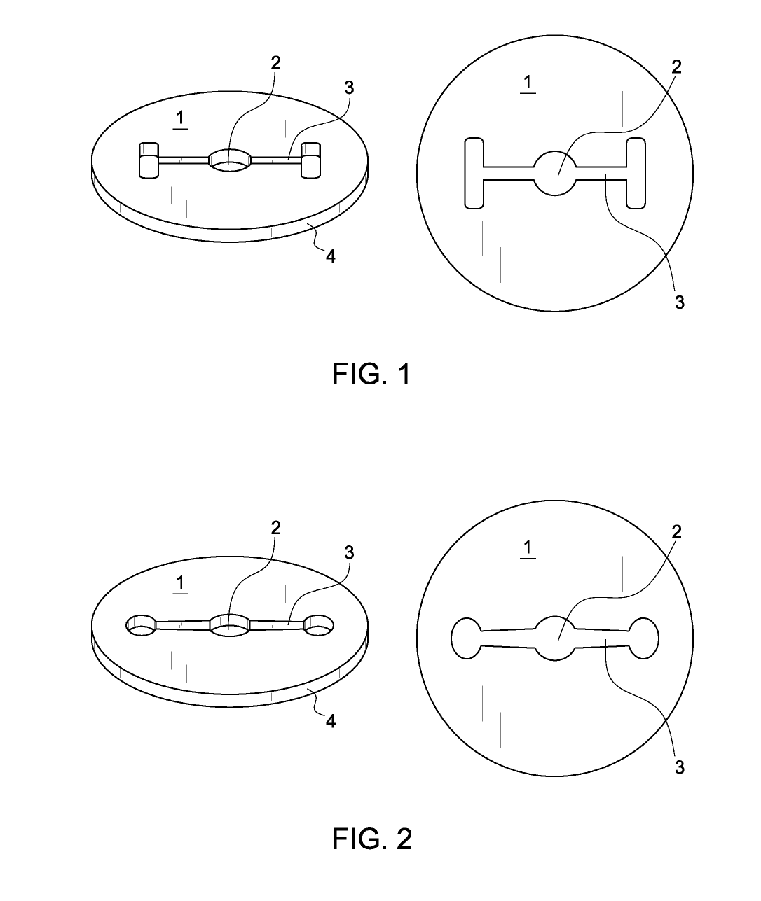

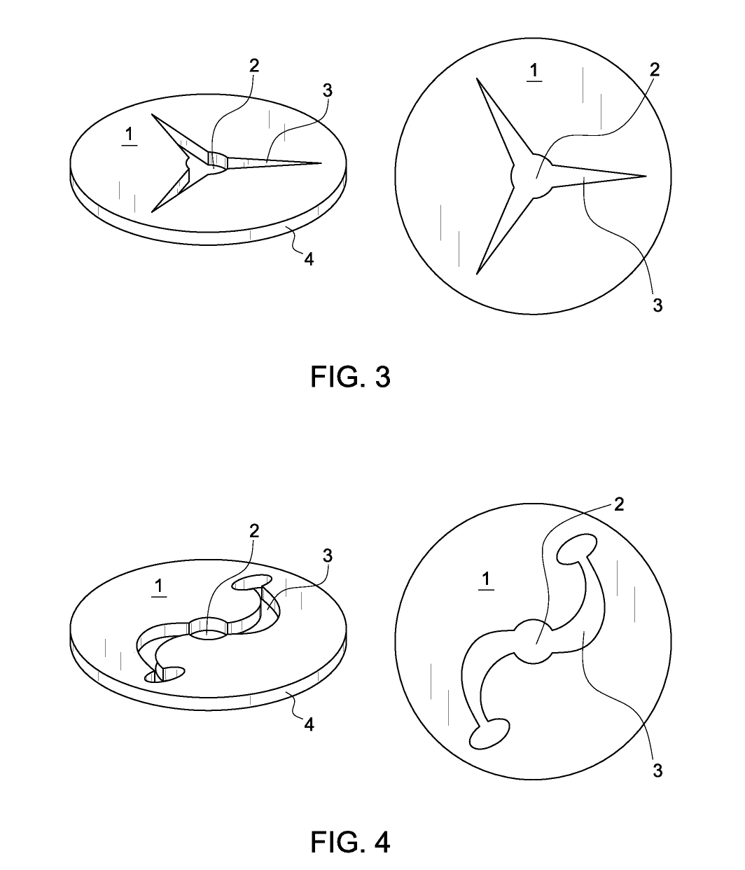

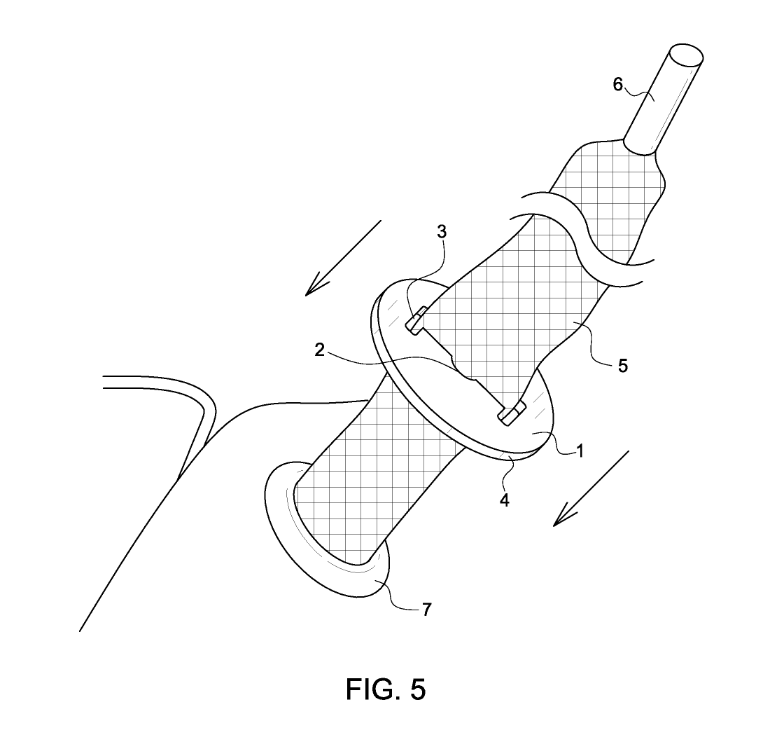

Refer to FIGS. 1-5. One embodiment involves two small, substantially circumferential disks 1 made of metal, plastic, vulcanized rubber, or some other composite material. Each of the disks 1 has a very small thickness 4 (but thick enough to be rigid or at least flexibly rigid) and a diameter of at least slightly greater than the eyelets of the article of footwear that they are to be applied to. It is generally expected that in most cases, each laced article of footwear 5 will require two such disks 1, one for each end of the footwear-securing lace 5. Each disk 1 has a shaped cutout or hole 2 disposed approximately in the center of the disk 1, which is roughly the size of the aglet 6 of the target shoelace 5 to apply tension to. In many embodiments, the center hole 2 also has one or more further cutouts 3 in the disk that expand from the center hole outwardly toward the perimeter of the disk 1, without breaching the perimeter of the disk 1, which can form in many cases something akin to a “ray”. The sides and shape of each “ray” cutout 3 is such that when an elasticized shoelace 5 is threaded through the cutout(s) 2, 3 of the disk 1, the disk 1 substantially resists retraction movement of the shoelace 5 from the disk 1. The disk 1 effectively has a clamping action on the shoelace 5. To release this clamping of the shoelace 5, the disk 1 must be held by a user while the user gently pulls the shoelace 5 straight with one hand while the hand holding the disk 1 can slidably release the disk's 1 grip on the shoelace 5.

The goal of this embodiment's general configuration is to insert each end of a shoe's shoelace 5 through the center of a disk 1 and draw the associated disk 1 down to a hard stop at the shoe's eyelet 7. That hard stop can either be on the outside of the shoe, at the top eyelet 7, or inside of the shoe at the inner part of the next-to-top (or lower) shoe eyelet 7. The disk slots or apertures 2, 3 will exert frictional and/or clamping tension of the shoelace 5, which is preferably elasticized for many embodiments. By maintaining tension on the shoelace 5 at locations around but below the top shoe eyelets 7, the wearer can wear the shoe with the confidence that it will not easily come off the wearer's foot, yet the wearer can wear and use the shoe with the appearance that the shoe remains untied. One embodiment toward this fashion aspect is to use the lace-clamping disks 1 between the top two rows of shoe eyelets 7 so that the lace-clamping disks 1 do not show, and the each end of the shoelace 5, 6 can be loosely threaded through the top shoe eyelets 7 and appear completely unrestrained to an outside observer.

The shape and size of the aperture cutouts 2, 3 in of the disks 1 can vary widely, as long as the sides and internal surfaces of the cutouts can have an effective gripping action on an inserted shoelace 5. To this end, the size and shape of the apertures 2, 3 can also serve an ornamental function when the devices are used on the exterior of the eyelets 7 of a target article of footwear, with no goal of being hidden. Further, the planar surfaces of the disks 1 can be have colors and other ornamentation for instances where a user chooses to secure shoelaces 5 in open view (that is, on the exterior side of the wearer's shoe eyelets 7). To this end, some wearers of shoes may enjoy adding much additional ornamentation to their footwear by having a pair of ornamented device disks 1 for each pair of eyelets 7 of the wearer's shoe (or some other fraction of the total number of eyelets), and the sizes of the disks 1 can be significantly large relative to the size of the eyelets in order to better display the ornamentation.

Finally, in many embodiments, the device can be used by other types of athletes besides skateboarders. For example, the devices can be used by tri-athletes who need to be able to don shoes quickly and don't want to spend much time tying them.

### Terminology

The terms and phrases as indicated in quotes (“ ”) in this section are intended to have the meaning ascribed to them in this Terminology section applied to them throughout this document, including the claims, unless clearly indicated otherwise in context. Further, as applicable, the stated definitions are to apply, regardless of the word or phrase's case, to the singular and plural variations of the defined word or phrase.

The term “or”, as used in this specification and the appended claims, is not meant to be exclusive; rather, the term is inclusive, meaning “either or both”.

References in the specification to “one embodiment”, “an embodiment”, “a preferred embodiment”, “an alternative embodiment”, “a variation”, “one variation”, and similar phrases mean that a particular feature, structure, or characteristic described in connection with the embodiment is included in at least an embodiment of the invention. The appearances of the phrase “in one embodiment” and/or “in one variation” in various places in the specification are not necessarily all meant to refer to the same embodiment.

The term “couple” or “coupled”, as used in this specification and the appended claims, refers to either an indirect or a direct connection between the identified elements, components, or objects. Often the manner of the coupling will be related specifically to the manner in which the two coupled elements interact.

The term “removable”, “removably coupled”, “readily removable”, “readily detachable”, and similar terms, as used in this patent application specification (including the claims and drawings), refer to structures that can be uncoupled from an adjoining structure with relative ease (i.e., non-destructively and without a complicated or time-consuming process) and can also be readily reattached or coupled to the previously adjoining structure.

Directional and/or relational terms such as, but not limited to, left, right, nadir, apex, top, bottom, vertical, horizontal, back, front, and lateral are relative to each other, are dependent on the specific orientation of an applicable element or article, are used accordingly to aid in the description of the various embodiments, and are not necessarily intended to be construed as limiting.

As applicable, the terms “about” and “generally” as used herein unless otherwise indicated means a margin of ±20%. Also, as applicable, the term “substantially” as used herein unless otherwise indicated means a margin of ±10%. It is to be appreciated that not all uses of the above terms are quantifiable such that the referenced ranges can be applied.

The term “eyelet”, as used in this specification and the appended claims, refers generally to any aperture in the upper section of an article of footwear that is designed to have lacing passed through in order to facilitate the tightening and securing of the article of footwear on a wearer's foot. An eyelet may have significant structure to define it, such as a metal or plastic ring that is substantially circular in shape. However, an eyelet can also be designed with other shapes, and may have very little structure other than the mere presence of a hole made in an article of footwear's upper material—that is, that may be no metal or plastic ring or similar device to define the eyelet aperture.

The term “aglet”, as used in this specification and the appended claims, refers to the protective cover or tip on a common shoelace (or any lace used to secure an article of footwear) that help prevent fraying on the ends of the lace, and makes such laces easier to tie and thread through footwear eyelets. Aglets are commonly made from plastic or metal.

The term “flexibly rigid”, as used in this specification and the appended claims, refers to a structural integrity that allows a structure to substantially maintain its manufactured shape, yet allows for some flexing of the manufactured shape to facilitate effective applied uses of the manufactured structure.

### First Embodiment

### A Device for Securing a Footwear Lace on an Article of Footwear

This embodiment is directed generally to a device for securing a footwear lace on an article of footwear. The article of footwear has at least one pair of eyelets through which the footwear laces are directed to facilitate the securing of the article footwear on a user's foot.

Refer to FIGS. 1-11. The device comprises a pair of fasteners 1, with an aperture 2, 3 in each fastener 1. Each fastener has a first face, a second face, and a perimeter edge 4. The first and second faces are each on a substantially parallel plane relative to the other face. The perimeter edge 4 has a thickness and is disposed between the first and second faces, and that thickness is small relative to either the first or second faces such that each fastener 1 is substantially planar as viewed looking directly at the surface of the perimeter edge 4. The aperture 2, 3 in each fastener 1 has a substantially centered first cutout 2, which is sized to allow the passage through of the aglet 6 of a target footwear lace 5. The aperture 2, 3 is adapted to receive the width and thickness of a target footwear lace 5, and is adapted to adjustably and frictionally clamp on a target footwear lace 5, without the need of any additional mechanical moving parts to aid in the frictional clamping, such that unintended slippage of a target footwear lace 5 relative to the position of the fastener 1 on a target footwear lace 5 is inhibited. In some variations, parts or all of the internal surfaces of the apertures 2, 3 have teeth, ribs, or other types of textures that can aid in the clamping action of the fastener 1.

Further, each fastener 1 is adapted to be engaged with a lace 5 for an article of footwear in a position above at least one eyelet 7 such that when both fasteners 1 are engaged with alternate ends of the footwear lace 5, the associated article of laced footwear is secured to the foot of a user.

In many embodiments, each fastener 1 is substantially shaped like a round disk. However, one ordinarily skilled in the art will appreciate that the fastener members 1 can be made to be many other planar shapes and still be effective. Similarly, the aperture cutouts 2, 3 can take on myriad shapes and still be effective.

This embodiment can be further enhanced wherein each fastener 1 aperture 2, 3 has at least one elongated slot 3, and the majority of the length of the at-least-one elongated slot 3 has a width that is smaller than that of the first cutout 2.

This embodiment can be further enhanced each fastener 1 aperture's first cutout 2 is disposed substantially in the middle of its fastener 1 aperture's at-least-one elongated slot 3.

This embodiment can be further enhanced wherein each fastener 1 aperture's at-least-one elongated slot 3 has a second cutout with a width that is wider than that of the associated at-least-one elongated slot 3.

This embodiment can be further enhanced wherein each fastener 1 aperture's first cutout 2 defines the common starting point for three of the at-least-one elongated slots 3, and each elongated slot 3 extends from the substantially centered first cutout 2 outward toward the perimeter edge 4 without breaching the perimeter edge 4. In many related embodiments involving this enhancement, the elongated slots 3 are substantially equally radially distributed relative to each other.

This embodiment can be further enhanced wherein the device 1 is substantially made from polymeric materials, co-polymeric materials, vulcanized rubber, and/or metal. If metal is used, corrosive-resistant metal is preferred; e.g., stainless steel. In some embodiments, the device 1 is substantially made from a thermoplastic elastomer. This enhancement can be further extended each fastener 1 is adapted to pliably receive a target footwear lace 5 through its aperture 2, 3.

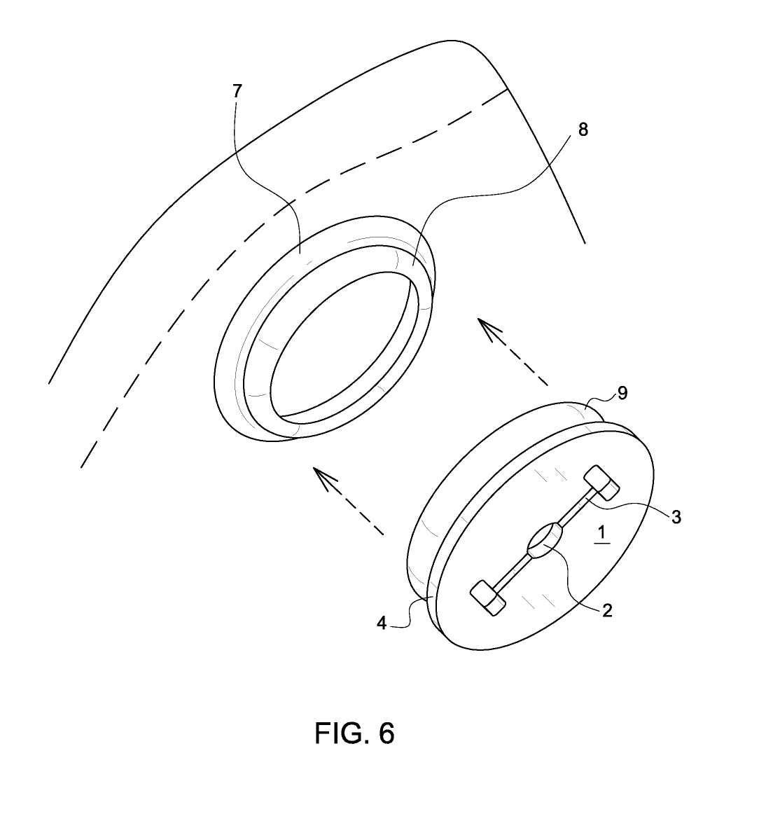

This embodiment can be further enhanced wherein each fastener 1 further comprises an attachment member 9 (see FIG. 6) adapted to be fixed to the interior-side of an eyelet 7, 8 of a target article of footwear. The goal of this enhancement is to allow the fasteners 1 to be attached to the top-most eyelet 7, 8 of an article of footwear and allow the securing of the footwear lace 5 while providing a false image that the article of footwear remains unsecured (that is, has an untied footwear lace). In some variations, the attachment member 9 of this enhancement can be a mechanical-snap fastener, an adhesive medium, or hook-and-loop fastener. Alternatively, in some embodiments the attachment member 9 can be fixed to the exterior side of an eyelet, if it is not important to the user to hide the fasteners 1 from view as the article of footwear is worn. Of course, if an attachment member 9 is used with a fastener 1, the target eyelet on the article of footwear must also be adapted to securely receive the attachment member 9. For example, if the attachment member 9 is a type of hollowed mechanical snap, then it must securely mate with the corresponding hollowed mechanical-snap attachment member 8 fixed to the target eyelet 7, where one side is a “male” member and the other side is a “female” member. In FIG. 6, for exemplary purposes only, the depicted embodiment shows that the fastener's 1 attachment member 9 is a hollowed “female” mechanical-snap member, with the attachment member 8 fixed to the target eyelet 7 is a “male” mechanical-snap member.

This embodiment can be further enhanced wherein each fastener 1 is integrally fixed to a different top-most eyelet 7 on an article of footwear, as a manufactured unit. In many embodiments, this manufactured unit presents each fastener 1 on the interior side of each fastener's 1 associated top-most eyelet 7, thus helping to maintain the false image of an unsecured article of footwear that is really properly secured to a user's foot.

### Second Embodiment

### A Method of Making a Device for Securing a Footwear Lace on an Article of Footwear

This embodiment is directed generally to a method for making a device for securing a footwear lace on an article of footwear. The article of footwear has at least one pair of eyelets through which the footwear laces are directed to facilitate the securing of the article footwear on a user's foot.

Refer to FIGS. 1-11. The method comprises the steps of providing a pair of fasteners 1, and providing an aperture 2, 3 in each fastener 1. Each fastener 1 has a first face, a second face, and a perimeter edge 4. The first and second faces are each on a substantially parallel plane relative to the other face. The perimeter edge 4 has a thickness and is disposed between the first and second faces, and that thickness is small relative to either the first or second faces such that each fastener 1 is substantially planar as viewed looking directly at the surface of the perimeter edge 4. The aperture 2, 3 in each fastener 1 has a substantially centered first cutout 2, which is sized to allow the passage through of the aglet 6 of a target footwear lace 5. The aperture 2, 3 is adapted to receive the width and thickness of a target footwear lace 5, and is adapted to adjustably and frictionally clamp on a target footwear lace 5 such that unintended slippage of a target footwear lace 5 relative to the position of the fastener 1 on a target footwear lace is inhibited. Further, each fastener 1 is adapted to be engaged with a lace 5 for an article of footwear in a position above at least one eyelet 7 such that when both fasteners 1 are engaged with alternate ends of the footwear lace 5, the associated article of laced footwear is secured to the foot of a user.

In many embodiments, each fastener 1 is substantially shaped like a round disk. However, one ordinarily skilled in the art will appreciate that the fastener members 1 can be made to be many other planar shapes and still be effective. Similarly, the aperture cutouts 2, 3 can take on myriad shapes and still be effective.

This embodiment can be further enhanced wherein each fastener 1 aperture 2, 3 has at least one elongated slot 3, and the majority of the length of the at-least-one elongated slot 3 has a width that is smaller than that of the first cutout 2.

This embodiment can be further enhanced each fastener 1 aperture's first cutout 2 is disposed substantially in the middle of its fastener 1 aperture's at-least-one elongated slot 3.

This embodiment can be further enhanced wherein each fastener 1 aperture's at-least-one elongated slot 3 has a second cutout with a width that is wider than that of the associated at-least-one elongated slot 3.

This embodiment can be further enhanced wherein each fastener 1 aperture's first cutout 2 defines the common starting point for three of the at-least-one elongated slots 3, and each elongated slot 3 extends from the substantially centered first cutout 2 outward toward the perimeter edge 4 without breaching the perimeter edge 4. In many related embodiments involving this enhancement, the elongated slots 3 are substantially equally radially distributed relative to each other.

This embodiment can be further enhanced wherein the device 1 is substantially made from polymeric materials, co-polymeric materials, vulcanized rubber, and/or metal. If metal is used, corrosive-resistant metal is preferred; e.g., stainless steel. In some embodiments, the device 1 is substantially made from a thermoplastic elastomer. This enhancement can be further extended each fastener 1 is adapted to pliably receive a target footwear lace 5 through its aperture 2, 3.

This embodiment can be further enhanced wherein the method further comprises the step of providing each fastener 1 with an attachment member 9 (see FIG. 6) adapted to be fixed to the interior-side of an eyelet 7, 8 of a target article of footwear. The goal of this enhancement is to allow the fasteners 1 to be attached to the top-most eyelet 7, 8 of an article of footwear and allow the securing of the footwear lace 5 while providing a false image that the article of footwear remains unsecured (that is, has an untied footwear lace). In some variations, the attachment member 9 of this enhancement can be a mechanical-snap fastener, an adhesive medium, or hook-and-loop fastener.

This embodiment can be further enhanced wherein the method further comprises the step of causing each fastener 1 to be integrally fixed to a different top-most eyelet 7 on an article of footwear, as a manufactured unit. In many embodiments, this manufactured unit presents each fastener 1 on the interior side of each fastener's 1 associated top-most eyelet 7, thus helping to maintain the false image of an unsecured article of footwear that is really properly secured to a user's foot.

### Third Embodiment

### Methods for Using a Device for Securing a Footwear Lace on an Article of Footwear

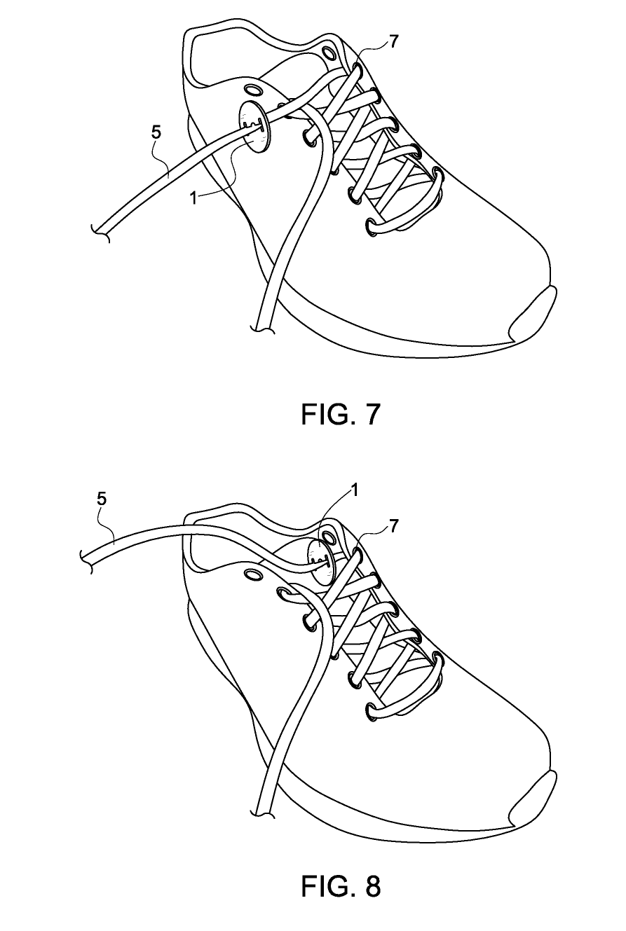

This embodiment is directed generally to methods of using a device for securing a footwear lace on an article of footwear. Refer to FIGS. 7-9. In one variation, the method comprises the steps of:
Obtaining a device 1 for securing a footwear lace according to the First Embodiment described supra;
Obtaining the article of footwear to be secured to the foot of a wearer, wherein the article of footwear has at least one pair of eyelets 7 through which a footwear lace 5 can be directed to facilitate the securing of the article of footwear on a wearer's foot, and the article of footwear has a footwear lace 5 for securing the article of footwear to a wearer's foot;
Ensuring that the footwear lace 5 is threaded through at least one pair of eyelets 7 of the article of footwear, with each end of the footwear lace 5 extending from a different eyelet 7;
At each end of the footwear lace 5, inserting the aglet 6 of the end of the footwear lace 5 through one of the fasteners 1 of the securing device, sliding the securing-device fastener 1 to a position on the footwear lace 5 just above the respective eyelet 7; and
For each fastener 1 of the securing device, adjusting the position of the securing-device fastener 1 to a position just above, or in immediate contact with, the associated eyelet 7, depending on the wearer's desired level of footwear lace tightness and security of fit on the wearer's foot.

Thus, despite not tying the footwear lace 5 as is normally done for a laced article of footwear, by causing each fastener 1 to be engaged with the lace 5 of the article of footwear in a position such that when both fasteners 1 are engaged, the article of laced footwear is secured to the wearer's foot. This can be a time saver for athletes needing to quickly don athletic shoes. Of course, as a practical matter, the length of the footwear lace 5 used should be not be so long as to present a tripping hazard due to the dangling exposed ends of the footwear lace 5.

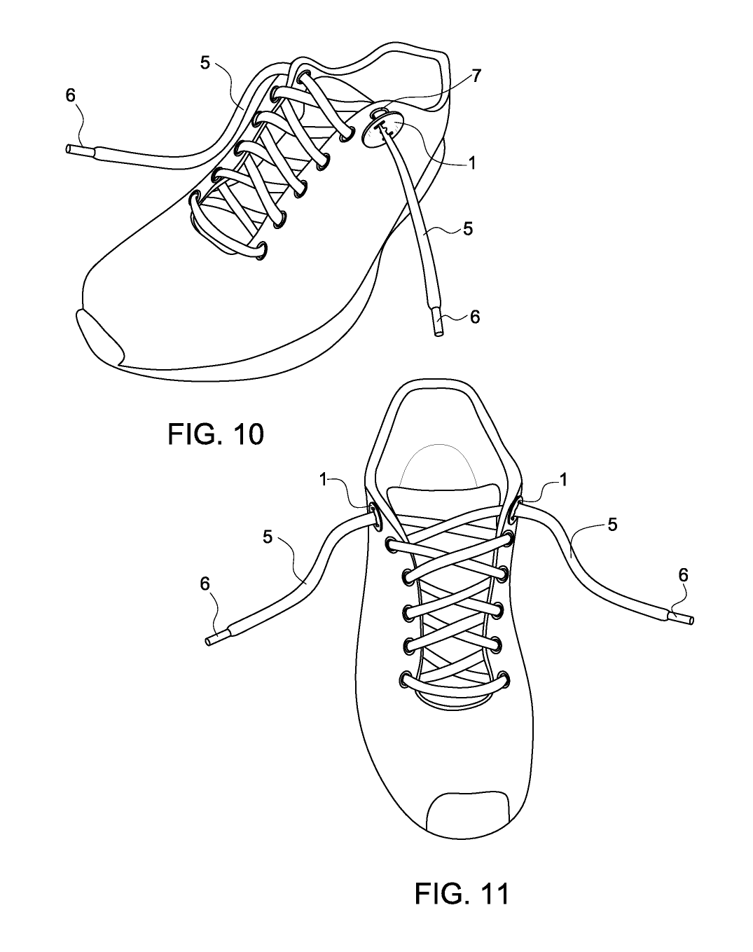

A variation of this embodiment is designed to both secure the footwear to a wearer's foot while also creating the false image that the article of footwear remains untied and unsecured. Refer to FIGS. 10-11. In this variation, the article of footwear has at least two pairs of eyelets 7 through which a footwear lace 5 is directed to facilitate securing of the article of footwear on a wearer's foot, and the article of footwear also has a top-most pair of eyelets 7 and at least one pair of second-tier (or lower) eyelets 7 disposed below the top-most pair of eyelets 7. In this variation, the method further comprises the steps of:
Ensuring that the footwear lace 5 is threaded through all but the top-most pair of eyelets 7 of the article of footwear;
Ensuring that the footwear lace 5 is threaded through the second-tier pair of eyelets 7 by having the aglet 6 at each end of the footwear lace 5 inserted into its respective second-tier eyelet 7 from the exterior side;
At each end of the footwear lace 5, ensuring that the securing-device fastener 1 is slid to a position on the footwear lace 5 just above the second-tier eyelet 7; and
Inserting each end of the footwear lace 5 through its associated top-most eyelet 7 on the article of footwear.

Thus, each fastener 1 is engaged with its respective end of the footwear lace 5 of the article of footwear in a position between a top-most eyelet 7 and a second-tier eyelet 7 such that the article of laced footwear is secured to the wearer's foot while maintaining a false impression that the laces of the article of footwear remain untied and unsecured.

After securing the laced article of footwear to a wearer's foot according to either of the above variations of this embodiment, the wearer must be able to easily remove the article of footwear. The method for accomplishing this comprises the steps of:
For each end of the footwear lace 5, stretching the end of the footwear lace 5 such that the frictional grip of the fastener 1 is at least relaxed; and
For each end of the footwear lace 5, sliding the fastener 1 toward the end of its respective footwear lace 5, thereby releasing tension in the footwear lace 5 for the article of footwear such that the article of footwear can be more easily removed from the wearer's foot.

### Fourth Embodiment

### Method for Ornamenting an Article of Footwear

This embodiment is directed generally to methods of using a device for ornamenting an article of footwear, using a device for securing a footwear lace on an article of footwear according to the First Embodiment discussed supra. Refer to FIGS. 10-11.

The shape and size of the aperture cutouts 2, 3 in the fasteners 1 of the securing device can vary widely, as long as the sides and internal surfaces of the cutouts 2, 3 can have an effective gripping action on an inserted footwear lace 5. To this end, the size and shape of the apertures 2, 3 can also serve an ornamental function when the devices 1 are used on the exterior of the eyelets 7 of a target article of footwear, with no goal of being hidden. Further, the planar surfaces of the fasteners 1 can be have colors and other ornamentation for instances where a user chooses to secure footwear laces 5 in open view (that is, on the exterior side of the wearer's shoe eyelets 7). To this end, some wearers of shoes may enjoy adding much additional ornamentation to their footwear by having a pair of ornamented device disks 1 for some or all of the eyelets 7 of the wearer's shoe (or some other fraction of the total number of eyelets 7), and the sizes of the disks 1 can be significantly large relative to the size of the eyelets 7 in order to better display the ornamentation.

Typically, the method for ornamenting an article of footwear comprises the steps of:
Obtaining a one or more devices 1 for securing a footwear lace 5 according to the First Embodiment described supra, wherein each fastener 1 of the one or more securing devices is ornamented on at least one of each fastener's planar surfaces;
Obtaining the article of footwear to be secured to the foot of a wearer, wherein the article of footwear has at least one pair of eyelets 7 through which a footwear lace 5 is directed to facilitate the securing of the article of footwear on a wearer's foot, and wherein the article of footwear has a footwear lace 5 for securing the article of footwear to a wearer's foot;
For each eyelet 7 of the article of footwear to be ornamented:
   Ensuring that the footwear lace 7 is threaded through the eyelet to be ornamented, and
   Inserting the aglet 6 of the end of the footwear lace 5 through one of the ornamented fasteners 1 of the one or more securing devices, sliding the securing-device fastener 1 to a position on the footwear lace 5 that abuts the respective eyelet 7 such that the ornamented fastener 1 is disposed on the exterior side of the respective eyelet 7; and
For each fastener 1 of the one or more securing devices, adjusting the position of the securing-device fastener 1 to a position just above, or in immediate contact with, the associated eyelet 7, depending on the wearer's desired level of footwear lace tightness and security of fit on the wearer's foot.

This embodiment can be further enhanced wherein the ornamentation of the fasteners 1 of the securing device(s) comprises user-selected color schemes, fastener shapes, fastener-surface textures, and/or printed patterns.

### Alternative Embodiments and Other Variations

The various embodiments and variations thereof described herein and/or illustrated in the accompanying Figures are merely exemplary and are not meant to limit the scope of the inventive disclosure. It should be appreciated that numerous variations of the invention have been contemplated as would be obvious to one of ordinary skill in the art with the benefit of this disclosure.

For example, the lace-securing device as described herein could be adapted to secure a variety of other articles of apparel that use lacing of some sort; e.g., jackets, sweatshirts, etc. Moreover, the method to use the ornamentation features of the device described herein can be similarly applied to many other laced articles of apparel.

Hence, those ordinarily skilled in the art will have no difficulty devising myriad obvious variations and improvements to the invention, all of which are intended to be encompassed within the scope of the claims which follow.

What is claimed is:

1. A device for securing a footwear lace on an article of footwear, said article of footwear having at least one pair of eyelets through which said footwear laces are directed to facilitate the securing of said article of footwear on a user's foot, the device comprising:
a pair of fasteners, each said fastener having a first face, a second face, and a perimeter edge,
wherein said first and second faces are each on a substantially parallel plane relative to the other face,
wherein said perimeter edge has a thickness and is disposed between said first and second faces, and
wherein said thickness is small relative to either said first or second faces such that each said fastener is substantially planar as viewed looking directly at the surface of said perimeter edge;
an aperture in each said fastener,
wherein said aperture has a substantially centered first cutout, said first cutout sized to allow the passage through of the aglet of a target footwear lace, and
wherein said aperture is adapted to receive the width and thickness of a target footwear lace, and is adapted to adjustably and frictionally clamp on a target footwear lace, without needing any additional mechanical moving parts to aid in said frictional clamping, such that unintended slippage of a target footwear lace relative to the position of said fastener on a target footwear lace is inhibited.

2. The device of claim 1, wherein each said fastener aperture has at least one elongated slot, the majority of the length of said at least one elongated slot having a width that is smaller than that of said first cutout.

3. The device of claim 2, wherein each said fastener aperture's first cutout is disposed substantially in the middle of its fastener aperture's at least one elongated slot.

4. The device of claim 2, wherein each said fastener aperture's at least one elongated slot has a second cutout with a width that is wider than that of the associated at least one elongated slot.

5. The device of claim 2, wherein:
each said fastener aperture's first cutout defines the common starting point for three of said at least one elongated slots;
each said elongated slot extends from said substantially centered first cutout outward toward said perimeter edge without breaching said perimeter edge; and
said elongated slots are substantially equally radially distributed relative to each other.

6. The device of claim 1, wherein the device is substantially made from a material selected from the group comprising polymeric materials, co-polymeric materials, vulcanized rubber, and corrosive-resistant metal.

7. The device of claim 6, wherein:
the device is substantially made from a thermoplastic elastomer; and
each said fastener is adapted to pliably receive a target footwear lace through its aperture.

8. The device of claim 1, wherein each said fastener further comprises an attachment member adapted to be fixed to the interior-side of an eyelet of a target article of footwear.

9. The device of claim 8, wherein each said attachment member is selected from the group comprising mechanical-snap fastener, adhesive medium, and hook-and-loop fastener.

10. The device of claim 1, wherein:
each said fastener is integrally fixed to a different top-most eyelet on an article of footwear, as a manufactured unit; and
each said fastener is fixed to the interior side of each said fastener's associated top-most eyelet.

11. A method for making a device for securing a footwear lace on an article of footwear, said article of footwear having at least one pair of eyelets through which said footwear laces are directed to facilitate the securing of said article of footwear on a user's foot, the method comprising the steps of:
providing a pair of fasteners, each said fastener having a first face, a second face, and a perimeter edge,
wherein said first and second faces are each on a substantially parallel planes relative to the other face,
wherein said perimeter edge has a thickness and is disposed between said first and second faces, and
wherein said thickness is small relative to either said first or second faces such that each said fastener is substantially flat in shape as viewed looking directly at the surface of said perimeter edge;
providing an aperture in each said fastener,
wherein said aperture has a substantially centered first cutout, said first cutout sized to allow the passage through of the aglet of a target footwear lace, and
wherein said aperture is adapted to receive the width and thickness of a target footwear lace, and is adapted to adjustably and frictionally clamp on a target footwear lace such that unintended slippage of a target footwear lace relative to the position of said fastener on a target footwear lace is inhibited.

12. The method of claim 11, further comprising the step of providing for each said fastener an attachment member adapted to be fixed to the interior-side of an eyelet of a target article of footwear.

13. The method of claim 12, wherein each said attachment member is selected from the group comprising mechanical-snap fastener, adhesive medium, and hook-and-loop fastener.

14. The method of claim 11, further comprising the step of causing each said fastener to be integrally fixed to a different top-most eyelet on an article of footwear, as a manufactured unit.

15. The method of claim 14, wherein each said fastener is fixed to the interior side of each said fastener's associated top-most eyelet.

16. A method for using a device for securing a lace for an article of footwear on the foot of a wearer according to claim 1, said article of footwear to be secured to the foot of a wearer having at least one pair of eyelets through which a footwear lace is directed to facilitate the securing of said article of footwear on a wearer's foot, and said article of footwear having a footwear lace for securing said article of footwear to a wearer's foot; the method comprising the steps of:
ensuring that said footwear lace is threaded through at least one pair of eyelets of said article of footwear, with each end of said footwear lace extending from a different eyelet;
at each end of said footwear lace, inserting the aglet of the end of said footwear lace through one of the fasteners of said securing device, sliding said securing-device fastener to a position on said footwear lace just above the respective said eyelet; and
for each fastener of said securing device, adjusting the position of said securing-device fastener to a position just above, or in immediate contact with, the associated eyelet, depending on said wearer's desired level of footwear lace tightness and security of fit on said wearer's foot;
thereby causing each fastener to be engaged with the lace of said article of footwear in a position such that when both fasteners are engaged, said article of laced footwear is secured to said wearer's foot.

17. The method of claim 16, wherein:
said article of footwear has at least two pairs of eyelets through which a footwear lace is directed to facilitate securing of said article of footwear on a wearer's foot; and
said article of footwear has a top-most pair of eyelets and a second-tier pair of eyelets disposed below said top-most pair of eyelets;
the method further comprising the steps of:
ensuring that said footwear lace is threaded through all but the top-most pair of eyelets of said article of footwear;
ensuring that said footwear lace is threaded through said second-tier pair of eyelets by having the aglet at each end of said footwear lace inserted into its respective second-tier eyelet from the exterior side;
at each end of said footwear lace, ensuring that said securing-device fastener is slid to a position on said footwear lace just above said second-tier eyelet; and
inserting each end of said footwear lace through its associated top-most eyelet on said article of footwear;
thereby causing each fastener to be engaged with the lace of said article of footwear in a position between a top-most eyelet and a second-tier eyelet such that when both fasteners are engaged, said article of laced footwear is secured to said wearer's foot while maintaining a false impression that the laces of said article of footwear remain untied and unsecured.

18. A method for using a device for securing a lace for an article of footwear, wherein said article of footwear has been donned by a wearer and wherein said article of footwear is secure in place by a footwear lace that is held tight by a device for securing a footwear lace according to claim 1, the method comprising the steps of:
for each end of said footwear lace, stretching the end of said footwear lace such that the frictional grip of said fastener is at least relaxed; and
for each end of said footwear lace, sliding said fastener toward the end of its respective footwear lace,
thereby releasing tension in said footwear lace for said article of footwear such that said article of footwear can be more easily removed from said wearer's foot.

19. A method for ornamenting an article of footwear, the method comprising the steps of:
obtaining a one or more devices for securing a footwear lace according to claim 1,
wherein each fastener of said one or more securing devices is ornamented on at least one of each said fastener's planar surfaces;
obtaining the article of footwear to be secured to the foot of a wearer,
wherein said article of footwear has at least one pair of eyelets through which a footwear lace is directed to facilitate the securing of said article of footwear on a wearer's foot, and
wherein said article of footwear has a footwear lace for securing said article of footwear to a wearer's foot;
for each eyelet of said article of footwear to be ornamented,
ensuring that said footwear lace is threaded through the eyelet to be ornamented, and
inserting the aglet of the end of said footwear lace through one of the ornamented fasteners of said one or more securing devices, sliding said securing-device fastener to a position on said footwear lace that abuts the respective said eyelet such that said ornamented fastener is disposed on the exterior side of the respective said eyelet; and
for each fastener of said one or more securing devices, adjusting the position of said securing-device fastener to a position just above, or in immediate contact with, the associated eyelet, depending on said wearer's desired level of footwear lace tightness and security of fit on said wearer's foot.

20. The method of claim 20, wherein said ornamentation of fasteners employs at least one user-selected ornamentation scheme selected from the group consisting of color schemes on at least one surface of said fastener surfaces, shape schemes of said fasteners, shape schemes of said fastener apertures, textured schemes on at least one surface of said fastener surfaces, and printed-pattern schemes on at least one surface of said fasteners.
